(19) United States
(12) Patent Application Publication
(10) Pub. No.: US 2012/0208031 A1
(43) Pub. Date: Aug. 16, 2012

(54) PRODUCING METHOD OF HOT MELT FILM RECYCLING AIRBAG SCRAPS FOR SHOES, AND HOT MELT FILM PRODUCED THEREBY

(76) Inventor: Hee-Dae PARK, Busan (KR)

(21) Appl. No.: 13/456,366

(22) Filed: Apr. 26, 2012

Related U.S. Application Data
(63) Continuation of application No. PCT/KR2009/006522, filed on Nov. 6, 2009.

(30) Foreign Application Priority Data
Oct. 26, 2009 (KR) 10-2009-0101582

(51) Int. Cl. B32B 27/40; C08G 18/06; B29C 47/06

(52) U.S. Cl. 428/423.3; 264/37.32; 156/243; 528/85

(57) ABSTRACT

Disclosed therein is a method of producing a hot melt film through the steps of collecting TPU film scraps, which are generated in large quantity when airbags for absorbing shock of shoes are manufactured, and mixing the collected film scraps with other composites to have the target properties of hot melt films, and particularly, a method of producing a hot melt film of a multi-layer structure by means of the co-extrusion method.

### REFERENCE TO RELATED APPLICATIONS

This is a continuation of pending International Patent Application PCT/KR2009/006522 filed on Nov. 6, 2009, which designates the United States and claims priority of Korean Patent Application No. KR 10-2009-0101582 filed on Oct. 26, 2009, the entire contents of which are incorporated herein by reference.

### FIELD OF THE INVENTION

The present invention relates to a producing method of hot melt film recycling airbag scraps for shoes and a hot melt film produced thereby, and more particularly, to a method of producing hot melt films through the steps of collecting airbag scraps for shoes, which were discarded or recycled for the substandard purpose after being used, mixing the airbag scraps with other composites so as to have the target properties for hot melt films, and reprocessing the airbag scraps into hot melt films of a single layer or a multi-layer by means of the co-extrusion method, and a hot melt film produced thereby.

### BACKGROUND OF THE INVENTION

As is well known, recently, shoes which are necessaries for the present-day life tend to be mordernized and fashionized. Shoes which are simple and have no special functions were the mainstream of shoes in times past, but recently, higher value-added products having innovative functions in aspects of feeling of wearing, shock absorption, and lightness are the mainstream of shoes. As the standards of living increase, such shoes are in increasing demand. Moreover, because shoes hold a seat of fashion, shoes of various designs have been developed and new concepts are grafted onto development of shoes.

In the meantime, there have been various attempts to make the shoes lightweight, to simplify the manufacturing process, or to achieve other development purposes. In order to make the shoes lightweight, methods of having similar effects to the existing shoes by using lightweight materials or using a small amount of materials through a change in design have been studied. In order to simplify the manufacturing process of shoes, recently, studies on technology to simplify the sewing process, which needs manpower and time the most out of the shoe manufacturing processes, or technology to manufacture shoes only through bonding without sewing have been actively done, and large portions of the studies have been applied in fact and are increasing rapidly.

In order to manufacture no-sewing shoes by removing the sewing process, adhesives are essential. However, in the case of liquid-phase adhesives, the drying process is needed and it is sometimes impossible to use the adhesives according to kinds of fiber fabrics. Hence, the process of bonding the fabric by inserting and thermally compressing hot melt films between the fabric and the substrate is used as an alternative. The hot melt films are generally produced by extruding thermoplastic polyurethane and thermoplastic polyethylene vinyl acetate resins into films, and are divided according to applicable purposes.

Such hot melt films serve to simply bond the surface fabric with the substrate fabric after being inserted between the surface fabric and the substrate fabric, and in this instance, the hot melt film is a film of a single layer structure. Recently, a method of using a hot melt film of a two-layer structure, which is a more improved structure, has been developed, and as an example, the hot melt film has an upper layer of a high-density thermoplastic polyurethane film and a lower layer of a polyurethane film. In this instance, the film is adhered on the surface of the fabric to be exposed to the outside. That is, the hot melt film assumes the form that the surface is laminated thermoplastic polyurethane and the fiber fabric is located below. Products to which the above technology is applied have been come into the market and the number of the products is continuously increasing.

Furthermore, as a similar example, the use of films of a double layer structure that polyurethane is coated on the surface of the polyurethane hot melt film is increasing, and such products have advantages in that the property of polyurethane resin can be easily adjusted and in that higher value-added and fashionable products can be manufactured because polyurethane can have various and unlimited colors.

As you can see from the above examples, application of hot melt films is gradually increasing, and it is very important to develop such technology and materials, but the development must be achieved in consideration of environment.

In the meantime, in order to solve environmental problems, the inventor of the present invention has studied to reduce the quantity of wastes and decrease the consumption of resources by reproducing thermoplastic polyurethane film scraps, which are generated during high frequency fusing machine work when shoes are manufactured, into a thermoplastic polyurethane film for high frequency fusion without discarding.

As a result, the inventor has filed an application for patent registration entitled “Producing method of thermoplastic polyurethane film for high frequency fusion recycling thermoplastic polyurethane film scraps and thermoplastic polyurethane film produced thereby” (Korean Patent Application No. 2008-113102 filed on Nov. 14, 2008) and a PCT international application for patent registration entitled “Thermoplastic polyurethane film” (PCT International Patent Application No. PCT/KR2008/006948 filed on Nov. 25, 2008).

As described above, the inventor of the present invention has studied the method of recycling and reproducing scraps of airbags, which are used for absorbing shock, into thermoplastic polyurethane hot melt films without discarding, and the product of the study is the technical idea of the present invention.

However, till now, such a study on the thermoplastic polyurethane hot melt film, preferably, on reproduction of the hot melt film recycling airbag scraps, has not yet been made, and particularly, a hot melt film of a triple layer structure has not yet been produced.

### SUMMARY OF THE INVENTION

Accordingly, the present invention has been made in an effort to solve the above-mentioned problems occurring in the prior arts, and it is an object of the present invention to provide a method of producing hot melt films using airbag scraps, which were discarded or recycled for the substandard purpose, and a hot melt film produced thereby.

It is another object of the present invention to provide a method of producing a hot melt film of a single layer structure or a multi-layer structure, such as a double layer structure or a triple layer structure, by recycling airbag scraps and a hot melt film produced thereby.

It is a further object of the present invention to provide a method of producing a hot melt film of a multi-layer structure by extruding once using the co-extrusion method without using the existing textile bonding method when the hot melt film of the multi-layer structure is produced, and a hot melt film produced thereby.

The present invention is characterized in that hot melt films are produced through the steps of collecting airbag TPU film scraps, which were discarded or recycled for the substandard purpose after being used, mixing the airbag scraps with other composites so as to have the target properties for hot melt films.

Moreover, the present invention is characterized in that a hot melt film of a multi-layer structure is produced by means of the co-extrusion method according to hot melt films of the single layer structure or according to use purposes.

### BRIEF DESCRIPTION OF THE DRAWINGS

FIG. 1 is a view showing a state where a hot melt film of a single layer structure produced using airbag scraps according to a first preferred embodiment of the present invention is adhered onto a fabric.

FIG. 2 is a view showing a state where a hot melt film of a double layer structure produced using airbag scraps according to a second preferred embodiment of the present invention is adhered onto a fabric.

FIG. 3a is a view showing a hot melt film of a triple layer structure having an intermediate layer produced using airbag scraps according to a third preferred embodiment of the present invention.

FIG. 3b is a view showing a hot melt film of a triple layer structure having an intermediate layer produced of thermoplastic polyurethane (TPU) according to a fourth preferred embodiment of the present invention.

FIG. 3c is a view showing a state where the hot melt film shown in FIGS. 3a and 3b is adhered on the fabric.

### DETAILED DESCRIPTION OF THE INVENTION

Reference will be now made in detail to a bicycle tire 1 of the present invention with reference to the attached drawings. The example embodiments described in this specification and the configurations illustrated in the drawings are just the most preferred embodiments of the present invention, and other embodiments which may be proposed in the present invention will be substituted with description on the structure of the present invention.

The term of ‘airbag scraps’ in the present invention means thermoplastic polyurethane film scraps, which are generated in abundance when airbags used for absorbing shock of shoes and are discarded, and the airbag scraps includes films of multi-layer structure in which polyethylene vinyl alcohol (poly EVHO) of many folds is laminated between the thermoplastic polyurethane films.

In addition, the airbag film has polyethylene vinyl alcohol laminated between the TPU films so as to prevent nitrogen gas filling the airbag from escaping, and the present invention is characterized in that such airbag scraps are used.

The present invention provides a method of reproducing a hot melt film through the steps of: collecting film scraps, which are generated in abundance when the airbag for absorbing shock is manufactured, and mixing the airbag scraps with other composites so as to have the target properties of the hot melt film, and particularly, a method of producing a hot melt film of a multi-layer structure by means of the co-extrusion method.

Meanwhile, as described above, when the hot melt film is produced using the airbag scraps, which were discarded, a hot melt film of a single layer structure and a hot melt film of a multi-layer structure may be respectively produced. The hot melt film of the single layer structure is a thermoplastic hot melt film reproduced by mixing the airbag scraps with thermoplastic polyurethane hot melt, thermoplastic polyester hot melt, and so on, and is used to be fused on a fiber fabric by means of the thermal press method or is used for label tags to indicate sizes and producing centers of shoes.

Moreover, the hot melt film of the multi-layer structure is applicable in various ways, and hence, only airbag scraps may be used for the uppermost layer of the hot melt film, or in order to enhance the properties, the uppermost layer is constructed of mixture where the airbag scraps and the refined thermoplastic polyurethane resin are mixed and the intermediate layer is constructed of thermoplastic polyurethane or thermoplastic polyester hot melt resin, so that a hot melt film of a double layer structure having different functions can be produced. Furthermore, a hot melt film of a triple layer structure that the upper layer is constructed of hot melt, the intermediate layer is constructed of airbag scraps or of mixture, in which the airbag scraps and the refined thermoplastic polyurethane resin are mixed in order to enhance properties of the hot melt film, and the lower layer is constructed of hot melt.

Particularly, the hot melt film of the multi-layer structure is extrusion-molded at once not by means of the lamination method but by means of the co-extrusion method. That is, it is preferable that the hot melt film of the multi-layer structure is produced at once through the co-extrusion, but the hot melt film may be produced by a method that two layers are formed by co-extrusion and then formed into a triple layer structure by means of the bonding method.

In the meantime, the airbag scraps described in the above are in an irregular plate form having a diameter of about 1 cm. When the airbag scraps in large quantity are extruded, it has possibility of changing pressure of resin inside an extruder, and the airbag scraps are not smoothly inserted into a material inlet. Accordingly, in order to solve the above problems, the airbag scraps are first extruded and processed into round pellets, and then, used as master batch (M/B) resins. As described above, when the airbag scraps are used in the form of master batch resins, materials can be inserted more smoothly, but there is little influence on the properties of the hot melt films even though the airbag scraps are used as they are without being processed into the master batch form.

Hereinafter, while the present invention has been described with reference to the particular illustrative embodiments, it is not to be restricted by the embodiments.

### Embodiment 1

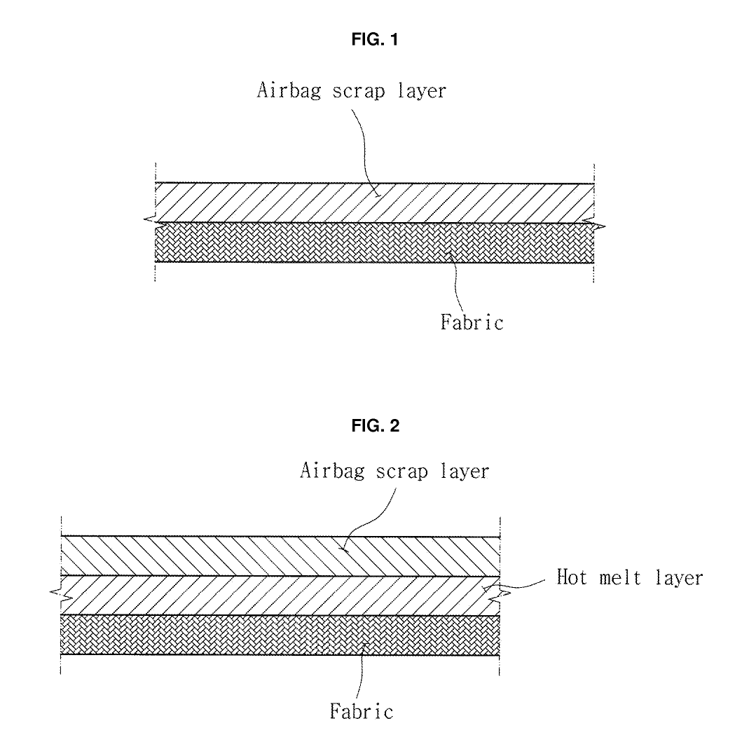

Referring to FIG. 1, the method of producing the hot melt film of the single layer structure according to the first preferred embodiment of the present invention will be described in detail, and the hot melt film is used for label tags attached to shoes.

In general, shoes respectively have labels attached to the inside of the shoes for indicating various kinds of information, such as the size of the shoes, manufacturing country, and so on. Such a label is called a size label, and the film used for the above purpose is called a label tag film. The film is thermally fused and attached to the surface of fabric located inside the shoe after the information is printed on the surface of the film. There is no example that reproduced TPU is used for the film, and hence, in the present invention, the properties of the airbag scraps were adjusted in such a fashion that the airbag scraps are suitable for the purpose of use.

In order to adjust the properties to be suitable for the purpose of use (namely, for the use of the label tag), mixing ratios of the airbag scraps and other composites are proposed in Table 1 and Table 2.

TABLE 1

| | Mixing Ratio |
|---|---|
| Composite | (% by weight) |
| Airbag scraps master batch | 30 |
| Refined TPU of 95A hardness | 50 |
| White pigment master batch | 17 |
| Yellowing prevention master batch | 3 |

TABLE 2

| | Mixing Ratio |
|---|---|
| Composite | (% by weight) |
| Airbag scraps master batch | 65 |
| Refined TPU of 95A hardness | 15 |
| White pigment master batch | 17 |
| Yellowing prevention master batch | 3 |

Hot melt films were respectively extruded in the mixing ratios proposed in Table 1 and Table 2, information (for instance, the size, manufacturing country of the shoes, and so on) was printed on the surface of the films, and then, the films were thermally fused on the fabric as shown in FIG. 1. As a result, there was no difference between the hot melt films produced in the above mixing ratios and the existing hot melt film produced using the existing TPU, and hence, the hot melt films are substitutable.

### Embodiment 2

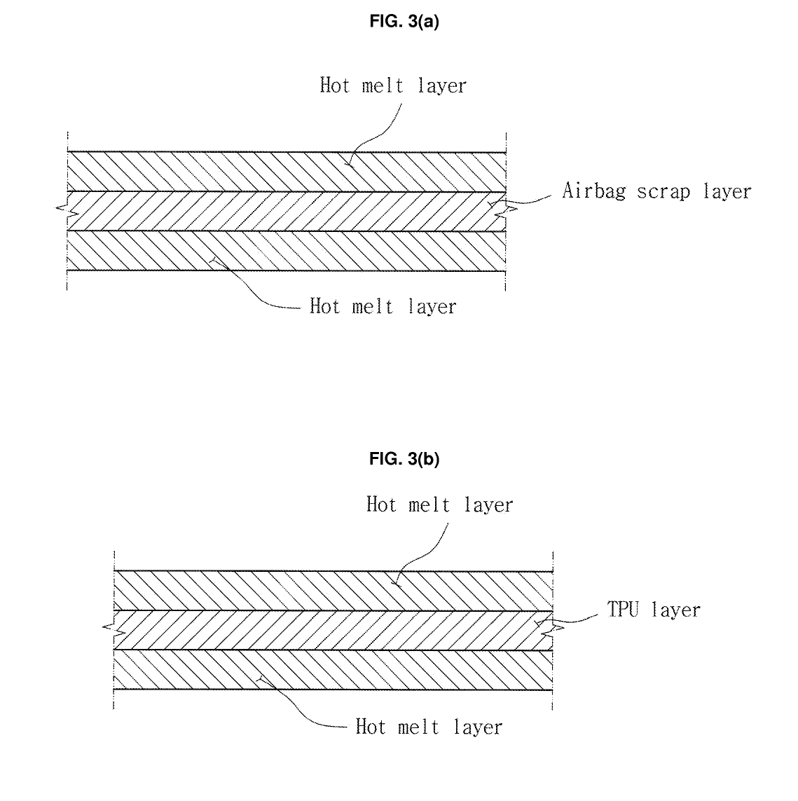

As shown in FIG. 2, in the second preferred embodiment, a reproduced hot melt film of a double layer structure having an airbag scrap layer and a hot melt layer will be described in detail.

The hot melt film having the double layer structure was produced through the steps of extruding a high-density TPU film on an upper layer and simultaneously extruding the hot melt on a lower layer by means of co-extrusion method so as to provide the thermal fusion property. Particularly, a great deal of airbag scraps were used for the upper layer of the hot melt film, and it has not been attempted till now and it can enhance the environmental-friendly extent of hot melt film products. Table 3 shows mixing ratios of the composites when the hot melt film of the double layer structure was produced.

TABLE 3

| | Mixing | | Mixing |
|---|---|---|---|
| Composite of | Ratio | Composite of | Ratio |
| upper layer | (% by | lower layer | (% by |
| (airbag scrap layer) | weight) | (hot melt layer) | weight) |
| Airbag scraps | 70 | Refined TPU hot | 70 |
| master batch | | melt of 85A hardness | |
| Refined TPU of | 20 | Refined TPU hot | 30 |
| 85A hardness | | melt of 80A hardness | |
| Refined TPU of | 10 | | |
| 95A hardness | | | |

In the hot melt mixing ratio of the lower layer (hot melt layer), viscosity of the entire mixing resins is very important. The melt flow index (MI), which is the most general viscosity measuring method, was used to obtain the relative viscosity. Viscosity may be changed according to thermal press conditions in the case of shoes, but work was good in MI of more than 10 g with the weight of 2.16 kg at 190 degrees. Moreover, the most preferably, good adhesion was achieved in MI of more than 20 g. In MI of more than 20 g, the hot melt was melted by heat, and then, easily penetrated into the fiber fabric by pressure, and hence, showed good adhesion. Kinds of hot melts should be changed according to kinds of fabrics, but appropriate MI is the most basic condition for hot melt films.

In the present invention, the thermal press conditions were temperature of 130° C. and pressure of 60 kg/cm², and may be changed a little according to kinds of fabrics.

In the mixing ratio of Table 3, as shown in FIG. 2, the hot melt film was extruded using a multi-layer co-extruder in such a way as to have the upper layer of thickness ranging 50 μm to 200 μm and the lower layer of thickness ranging 100 μm to 200 μm, but the thicknesses of the upper layer and the lower layer may be extruded up to 1 mm.

Meanwhile, the hot melt film extruded in the mixing ratio of Table 3 was adhered on the fabric by means of thermal press work as shown in FIG. 2, and then, was tested in properties. The result of the test is shown in Table 4.

TABLE 4

| | |
|---|---|
| Standard property | Test result |

| | | | | |
|---|---|---|---|---|
| Stoll abrasion | 80 | times | 90 | times |
| Adhesion | 2.5 | kgf/cm | 3.0 | kgf/cm |
| Bally FLEX | 70000 | times | 70000 | times |

Particularly, the bally flex test was very good. In case of the film produced by the existing multi-layer film producing method, it is generally difficult to overcome the test ten thousand times because the TPU layer of the upper layer and the hot melt layer of the lower layer is easily separated from each other by the repeated bally FLEX. However, the double-layer hot melt film produced by the co-extrusion method according to the present invention could prove superiority in the producing process because the airbag scrap layer and the hot melt layer were not separated from each other by the repeated bally FLEX.

In the meantime, the following Table 5 shows a mixing ratio in conditions that the amount of the airbag scrap master batch was decreased and the amount of refined TPU was increased.

TABLE 5

| | Mixing | | Mixing |
|---|---|---|---|
| Composite of | Ratio | Composite of | Ratio |
| upper layer | (% by | lower layer | (% by |
| (airbag scrap layer) | weight) | (hot melt layer) | weight) |
| Airbag scraps | 20 | Refined TPU hot | 55 |
| master batch | | melt of 85A hardness | |
| Refined TPU of | 70 | Refined TPU hot | 25 |
| 85A hardness | | melt of 80A hardness | |
| Refined TPU of | 10 | Polyester hot melt | 20 |
| 95A hardness | | | |

The color of the hot melt film was become more transparent when the amount of the refined TPU was increased, and the lower layer (hot melt layer) was enhanced in adhesion to the fiber fabric by mixing polyester-based hot melt. The polyester-based hot melt has good adhesion force to the fiber fabric but deteriorates transparency of the hot melt film and make the hot melt film hard due to its strong crystallizability, and hence, is restricted in used amount.

Accordingly, through the test, it was found that 10% to 30% by weight of the entire mixing ratio was the best. When the mixing ratio was lower than the above, adhesion was decreased, and when the mixing ratio was higher than the above, the hot melt film became hard or opaque. Table 6 shows the result of the above test.

TABLE 6

| | |
|---|---|
| Standard property | Test result |

| | | | | |
|---|---|---|---|---|
| Stoll abrasion | 80 | times | 100 | times |
| Adhesion | 2.5 | kgf/cm | 4.0 | kgf/cm |
| Bally FLEX | 70000 | times | 70000 | times |

The following Table 7 shows a test result of the hot melt film presented in Tables 3 and 4, and preferably, the hot melt film was extruded in the mixing ratio that the airbag scraps were not used in order to compare the physical properties of the hot melt film produced using airbag scraps with the physical properties of the hot melt film produced without using the airbag scraps.

TABLE 7

| | Mixing | | Mixing |
|---|---|---|---|
| Composite of | Ratio | Composite of | Ratio |
| upper layer | (% by | lower layer | (% by |
| (airbag scrap layer) | weight) | (hot melt layer) | weight) |
| Refined TPU of | 90 | Refined TPU hot | 70 |
| 85A hardness | | melt of 85A hardness | |
| Refined TPU of | 10 | Refined TPU hot | 30 |
| 95A hardness | | melt of 80A hardness | |

Table 8 shows physical properties (test result) of the hot melt film produced according to the mixing ratio of Table 7.

TABLE 8

| | |
|---|---|
| Standard property | Test result |

| | | | | |
|---|---|---|---|---|
| Stoll abrasion | 80 | times | 110 | times |
| Adhesion | 2.5 | kgf/cm | 3.5 | kgf/cm |
| Bally FLEX | 70000 | times | 70000 | times |

As shown in Table 8, the stoll abrasion was enhanced a little, but the hot melt film according to Table 3 showed sufficient properties, and there was no definite difference in adhesion and bally FLEX between the case that the airbag scrap master batch was used and the case that the airbag scrap master batch was not used.

### Embodiment 3

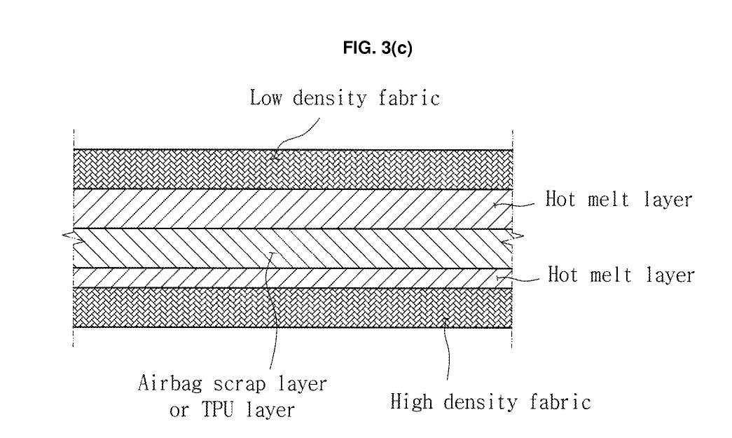

As shown in FIGS. 3a to 3c, in the third preferred embodiment, a reproduced hot melt film of a triple layer structure that hot melt layers are respectively arranged at the upper layer and the lower layer and an airbag scrap layer or a TPU layer is arranged at the intermediate layer will be described in detail.

The general hot melt film of the single layer structure may cause a problem when two kinds of fabrics which have different organizational structures. For instance, when a fabric with a low density and a fabric with a high density are bonded together by means of the thermal fusion method using the hot melt film, the hot melt fused by heat tends to be easily absorbed to the low density fabric. Accordingly, the hot melt is concentrated on one side fabric, and hence, adhesion gets lowered.

In order to prevent the hot melt from being concentrated on one side, as shown in FIGS. 3a and 3b, the hot melt film of the double layer structure that has the airbag scrap layer or the TPU layer between the hot melt layer and the hot melt layer was produced. The airbag scrap layer or the TPU layer of the intermediate layer serves as a barrier to prevent the unintended concentration of the hot melt on one side. Tables 9 and 12 show mixing ratios of the hot melt films.

TABLE 9

| Composite of | | Intermediate | | Composite of | |
|---|---|---|---|---|---|
| upper layer | Mixing Ratio | layer | Mixing Ratio | lower layer | Mixing Ratio |
| (airbag scrap layer) | (% by weight) | (TPU layer) | (% by weight) | (hot melt layer) | (% by weight) |
| Refined TPU | 70 | Refined TPU of | 100 | Refined TPU | 70 |
| hot melt of | | 85A hardness | | hot melt of | |
| 85A hardness | | | | 85A hardness | |
| Refined TPU | 30 | | | Refined TPU | 30 |
| hot melt of | | | | hot melt of | |
| 80A hardness | | | | 80A hardness | |

In the hot melt film of the triple layer structure, thicknesses of the upper layer and the lower layer may be changed according to kinds of fabrics to be bonded together, and preferably, may be change within the range of 30 μm to 300 μm. As mentioned above, because the low-density fabric absorbs lots of resin, the hot melt is extruded in such a fashion that the hot melt layer is formed thick on the low-density fabric but the hot melt layer is formed relatively thin on the high-density fabric. In this instance, it is appropriate that the TPU layer (airbag scrap layer) of the intermediate layer is within a range of 30 μm to 200 μm, but if the TPU layer exceeds the range, the entire thickness of the hot melt film becomes thick after being adhered on the fabric, and hence, productivity is deteriorated. Table 10 shows physical properties (test result) of the hot melt film produced in the mixing ratio of Table 9.

TABLE 10

| | Standard property | Test result |
|---|---|---|
| Adhesion | 2.5 kgf/cm | 3.0~3.5 kgf/cm |

As shown in Table 10, the hot melt showed good adhesion of 3.0 to 3.5 kgf/cm. General hot melt films of the single layer structure show low adhesion force of less than 2 kgf/cm, but the hot melt film of the triple layer structure according to the present invention could perfectly solve such a problem.

Moreover, hot melt films fused just by means of the thermal press sometimes did not show sufficient adhesion force. The reason is that the hot melt films could not obtain sufficient penetrating force because heat of the press could not sufficiently transferred to the hot melt film due to the thickness of the fabric and the hot melt was not melted. However, like the present invention, when the thermal press and high frequency heating were applied together, the hot melt could be melted better, and hence, the hot melt film could obtain sufficient penetrating force. The reason is that thermal press transfers heat to the hot melt film by means of thermal conductivity, but in the case of a thick fabric, heat is not sufficiently transferred due to an unintended insulating effect, however, the high frequency heating momentarily transfers energy to molecules by an electromagnetic field, so that the hot melt film is easily heated and melted and penetrates smoothly.

Meanwhile, in order to obtain a good result without any influence on adhesion force, it was proper that the condition for the high frequency work was 0.5 A to 1.5 A, the heating period of time was 5 seconds to 15 seconds, the cooling period of time was 5 seconds to 15 seconds, and temperature was within the range of 100° C. at room temperature.

Table 11 shows a physical property (test result) of the hoot melt film when a high frequency press was applied.

TABLE 11

| | Standard property | Test result |
|---|---|---|
| Adhesion | 2.5 kgf/cm | 5 kgf/cm |

As shown in Table 11, there was a considerable difference in adhesion force between the case that the thermal press and the high frequency press were applied together and the case that the fabric was adhered just by the thermal press.

In the meantime, Table 12 shows a mixing ratio and composite when the airbag scrap layer was formed as shown in FIG. 3a without forming the TPU layer at the intermediate layer of the hot melt film.

TABLE 12

| | | Intermediate | | | |
|---|---|---|---|---|---|
| Upper layer | Mixing Ratio | layer | Mixing Ratio | Lower layer | Mixing Ratio |
| (hot melt layer) | (% by weight) | (TPU layer) | (% by weight) | (hot melt layer) | (% by weight) |
| Refined TPU | 55 | Airbag scrap | 100 | Refined TPU | 55 |
| hot melt of | | master batch | | hot melt of | |
| 85A hardness | | | | 85A hardness | |
| Refined TPU | 25 | | | Refined TPU | 25 |
| hot melt of | | | | hot melt of | |
| 80A hardness | | | | 80A hardness | |
| Polyester | 20 | | | Polyester | 20 |
| hot melt | | | | hot melt | |

In Table 12, the airbag scraps were used at the intermediate layer of the hot melt film so as to provide the environmental-friendly effect, and polyester hot melt was added to the upper layer hot melt and the lower layer hot melt in order to improve the adhesion force. Table 13 shows a physical property (test result) of a hot melt film produced in the mixing ratio of Table 12.

TABLE 13

| | Standard property | Test result |
|---|---|---|
| Adhesion | 2.5 kgf/cm | 4.0 kgf/cm |

As shown in Table 13, also in the case that the airbag scrap master batch was used at the intermediate layer of the hot melt film instead of the refined TPU, it showed the same test result as the above embodiments. Moreover, polyester hot melt was mixed so as to improve the adhesion force.

Meanwhile, Table 13 shows the test result when the hot melt film was adhered on the fabric just by the thermal press work as shown in FIG. 3c, but Table 14 shows the test result when the hot melt film was adhered on the fabric by the thermal press work and the high frequency heating work.

TABLE 14

| | Standard property | Test result |
|---|---|---|
| Adhesion | 2.5 kgf/cm | 6.0 kgf/cm |

As shown in Table 14, when the high frequency heating work was added, the adhesion force was considerably enhanced.

### INDUSTRIAL APPLICABILITY

The hot melt films produced by reprocessing the airbag scraps generated when airbags used for absorbing shock of shoes can remarkably reduce generation of wastes and prevent environmental pollution.

Moreover, the present invention can provide an economic effect and reduce expenses because it uses airbag scraps, which were discarded or recycled for the substandard purpose, to manufacture hot melt films. Additionally, the hot melt films produced by the above method can provide the same physical properties as the typical hot melt films, and hence, create a higher value at small cost.

1. A method of producing a hot melt film using thermoplastic polyurethane film scraps used when airbags for shoes are manufactured.

2. The producing method according to claim 1, wherein the hot melt film is constructed of a single layer structure or a multi-layer structure.

3. The producing method according to claim 2, wherein an upper layer of the hot melt film is produced of thermoplastic polyurethane film scraps and a lower layer is produced of thermoplastic polyurethane hot melt.

4. The producing method according to claim 3, wherein the lower layer of the hot melt film is produced by mixing the thermoplastic polyurethane hot melt and a polyester hot melt.

5. The producing method according to claim 2, wherein an upper layer and a lower layer of the hot melt film are produced of thermoplastic polyurethane hot melts and an intermediate layer is produced of thermoplastic polyurethane or thermoplastic polyurethane film scraps.

6. The producing method according to claim 5, wherein the upper layer or the lower layer of the hot melt film is produced by mixing the thermoplastic polyurethane hot melt and a polyester hot melt.

7. The producing method according to claim 5, wherein when the upper and lower layers of the thermoplastic polyurethane hot melt are produced, the thermoplastic polyurethane hot melt adhered on a low-density fabric is formed relatively thick and the thermoplastic polyurethane hot melt adhered on a high-density fabric is formed relatively thin.

8. The producing method according to claim 7, wherein thicknesses of the upper layer and the lower layer of the hot melt film are within the range of 30 μm to 300 μm and thickness of the intermediate layer is within the range of 30 μm to 200 μm.

9. The producing method according to claim 5, wherein the hot melt film is adhered on the fabric by means of thermal press work and high frequency work.

10. The producing method according to claim 9, wherein the condition for the high frequency work was 0.5 A to 1.5 A, the heating period of time was 5 seconds to 15 seconds, and the cooling period of time was 5 seconds to 15 seconds.

11. The producing method according to claim 3, wherein the hot melt films are simultaneously extrusion-molded by means of the co-extrusion method.

12. The producing method according to claim 3, wherein the thermoplastic polyurethane film scraps have a multi-layer structure that polyethylene vinyl alcohol in many folds is laminated between the thermoplastic polyurethane films.

13. The producing method according to claim 3, wherein the thermoplastic polyurethane film scraps are extruded and processed into pellets and produced into master batch resins.

14. A hot melt film produced by the method according to claim 1.

15. The hot melt film according to claim 14, wherein an upper layer and a lower layer of the hot melt film are produced of thermoplastic polyurethane hot melts and an intermediate layer is produced of thermoplastic polyurethane.

16. The hot melt film according to claim 14, wherein an upper layer and a lower layer of the hot melt film are produced of thermoplastic polyurethane hot melts and an intermediate layer is produced of thermoplastic polyurethane film scraps generated when airbags for shoes are manufactured.
